(19) United States
(12) Patent Application Publication
(10) Pub. No.: US 2010/0018750 A1
(43) Pub. Date: Jan. 28, 2010

(54) CURABLE EPOXY RESIN COMPOSITION

(75) Inventors: Stephane SCHAAL, Sierentz (FR); Patricia Gonzalez, Zaragoza (ES); Cherif Ghoul, Mulhouse (FR); Jens Rocks, Freinbach (CH); Francisco Arauzo, Zaragoza (ES); Patrick Meier, Staufen (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 12/572,872

(22) Filed: Oct. 2, 2009

Related U.S. Application Data
(63) Continuation of application No. PCT/EP2008/052893, filed on Mar. 12, 2008.

(30) Foreign Application Priority Data
Apr. 3, 2007 (EP) 07105538.8

(51) Int. Cl. H01B 3/00; C08L 63/02; C08J 5/00

(52) U.S. Cl. 174/137 B; 523/400; 523/456; 523/440; 523/466; 264/331.11

(57) ABSTRACT

A curable epoxy resin composition is provided. The composition includes at least one diglycidyl ether of bisphenol A (DGEBA) and at least one diglycidyl ether of bisphenol F (DGEBF) as epoxy resins, in which the weight ratio of DGEBA:DGEBF is within the range of about 15:85 to 45:55; (ii) an anhydride hardener; (iii) and at least one plasticizer. The composition can additionally include a catalyst, at least one filler material and/or further additives. The dynamic complex viscosity value (η*) of the composition is within the range of 0.1 to 20 Pa·s. The present disclosure also provides a process for making the composition and electrical articles including an electrical insulation system made from the composition.

### RELATED APPLICATIONS

This application claims priority as a continuation application under 35 U.S.C. §120 to PCT/EP2008/052893, which was filed as an International Application on Mar. 12, 2008 designating the U.S., and which claims priority to European Application 07105538.8 filed in Europe on Apr. 3, 2007. The entire contents of these applications are hereby incorporated by reference in their entireties.

### FIELD

The present disclosure relates to a curable epoxy resin composition, a process of making the composition, and electrical articles including an electrical insulation system made from the composition.

### BACKGROUND INFORMATION

Cured epoxy resin compositions include a broad class of polymeric materials having a wide range of physical properties. The large spectrum of properties available with cured epoxy resin compositions have made them particularly useful in electrical and electronic applications, such as insulating materials in the manufacture of transformers, switchgears, and circuit breakers in medium and high voltage applications. Compared to other insulating materials, cured epoxy resin compositions exhibit excellent mechanical and electrical properties, temperature and long-term creep stability, chemical resistance, and are cost-effective.

Epoxy resins are polyepoxide monomers or polymers containing generally two or more epoxide groups per molecule which generally are cured by reaction with hardeners (also known as curing agents). The prime function of the hardener is to react with the epoxide groups within the mixture to propagate the crosslinking of the resin. Epoxy resins compositions may further contain catalysts (also named accelerators) to catalyze such crosslinking reaction, as well as additives such as fillers, plasticizing agents (flexibilizers), stabilizers and other ingredients.

Cured epoxy resin compositions must have defined performance properties, especially a good thermal and chemical stability at high operating temperatures, in addition to good mechanical properties, especially a good resistance to thermal shock. However, cured epoxy resin compositions having good thermal and chemical stability at high operating temperatures are generally rather brittle and therefore have a rather poor resistance to thermal shocks, i.e. have a rather low crack resistance. One known way to improve the crack resistance of epoxies is the addition of a plasticizing agent to the curable epoxy resin composition, as disclosed e.g. in U.S. Pat. No. 4,587,452. However, the addition of a plasticizing agent usually leads to a decrease of the mechanical properties, e.g. in tension and bending. The addition of a plasticizing agent also leads to a lower glass transition temperature (Tg), which is an important parameter when considering the temperature at which a device is allowed to operate safely. For structural applications, for example, the operating temperature should be at least 30° K below the Tg of the material. Lowering the Tg of the material therefore means lowering its operating temperature.

There is a need for a material, based on epoxy technology, that has good thermal and chemical stability at high operating temperatures as well as an improved resistance to thermal shock, while maintaining the Tg and the mechanical properties as high as possible, and also allowing the use of known processing techniques.

Suitable processing techniques include the Automatic Pressure Gelation (APG) Process and the Vacuum Casting Process. In the latter technique, the solventless, liquid epoxy resin composition is poured into a mold and cured to a solid-shaped article at an elevated temperature. Afterwards, the demolded part is usually post-cured at elevated temperatures to complete the curing reaction and to obtain a hardened resin with the ultimate desired properties.

It has now been found that a selected curable epoxy resin composition comprising a selected combination of at least a diglycidyl ether of bisphenol A (DGEBA) and at least a diglycidyl ether of bisphenol F (DGEBF) as epoxy resins, an anhydride hardener, and at least one plasticizer, yields a cured resin composition that has excellent thermal and chemical stability at high operating temperatures and shows a significantly improved resistance to thermal shock, while maintaining the Tg, combined with significantly improved mechanical properties of the composition, compared to known compositions. It further allows the use of current processing techniques.

Using a plasticizer, which can be solid at room temperature, leads generally to an increase of the viscosity of the curable epoxy resin composition, so that the viscosity of the composition may need to be adjusted to be within the range of a dynamic complex viscosity value (η*) within the range of 0.1 to 20 Pa·s, measured according to the ISO standard 6721-10, second edition (dated 1999, part 10). This can easily be done by increasing the amount of DGEBF relative to the amount of DGEBA present and represents no problem to the person skilled in the art.

The composition can be cured at elevated temperatures, such as within the range of 80° C.-160° C., and 100-160° C., for example, yielding a cured epoxy resin composition having surprisingly good properties if compared with other known curable epoxy resin compositions, e.g. when compared with compositions of EP 1 491 566, where curable epoxy resin compositions are described based on diglycidyl ethers of bisphenol A (DGEBA).

### SUMMARY

An exemplary embodiment of the present disclosure provides a curable epoxy resin composition. The exemplary composition includes (i) at least one diglycidyl ether of bisphenol A (DGEBA) and at least one diglycidyl ether of bisphenol F (DGEBF) as epoxy resins, in which the weight ratio of DGEBA:DGEBF is within the range of about 15:85 to 45:55; (ii) an anhydride hardener; and (iii) at least one plasticizer. The dynamic complex viscosity value (η*) of the composition can be within the range of 0.1 to 20 Pa·s, as measured according to the ISO standard 6721-10.

An exemplary embodiment of the present disclosure provides a process for making a shaped article using a composition. The exemplary process can include: (a) preheating a curable liquid epoxy resin composition comprising (i) at least one diglycidyl ether of bisphenol A (DGEBA) and at least one diglycidyl ether of bisphenol F (DGEBF) as epoxy resins, (ii) an anhydride hardener; and (iii) at least one plasticizer, wherein the weight ratio of DGEBA:DGEBF is within the range of about 15:85 to 45:55, and the dynamic complex viscosity value (η*) of the composition is within the range of 0.1 to 20 Pa·s; (b) transferring the composition into a pre-heated mold; and (c) curing the composition at an elevated temperature for a time sufficient to obtain a shaped article with an infusible cross-linked structure.

An exemplary embodiment also provides an electrical article containing an electrical insulation system including the above-described exemplary composition.

### DETAILED DESCRIPTION

With the composition of the present disclosure, it is possible to produce cured epoxy resin compositions as structural composites with improved physical and mechanical properties which have special advantages for the encapsulation of electrical devices, including, for example, cast coils for dry type distribution transformers, including, vacuum cast dry distribution transformers, within which a resin structure contains electrical conductors.

The present disclosure provides a curable epoxy resin composition. According to an exemplary embodiment, the composition can include:
(i) at least one diglycidyl ether of bisphenol A (DGEBA) and at least one diglycidyl ether of bisphenol F (DGEBF) as epoxy resins, in which the weight ratio of DGEBA:DGEBF is within the range of about 15:85 to 45:55;
(ii) an anhydride hardener;
(iii) at least one plasticizer, such as a diol, including a diol which is solid at room temperature, for example;
(iv) optionally a catalyst, at least one filler material and/or any additional additives.

According to an exemplary embodiment, the dynamic complex viscosity value (η*) of the composition can be within the range of 0.1 to 20 Pa·s.

According to an exemplary embodiment, the weight ratio of DGEBA:DGEBF is within the range of about 20:80 to 40:60; such as 25:75 to 35:65, for example.

Diglycidyl ether of bisphenol A (DGEBA) corresponds to the following chemical formula:

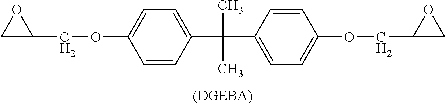

Diglycidyl ether of bisphenol F (DGEBF), as p,p′-bisglycidyl-oxyphenyl-methane, is represented by the chemical formula:

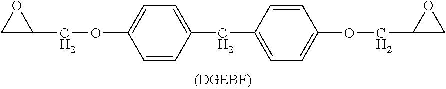

When producing diglycidyl ether of bisphenol F (DGEBF), however, there can be obtained a mixture of isomeric compounds, such as a mixture of o,o′-, o,p′- and p,p′-bisglycidyloxyphenylmethane.

Suitable anhydride hardeners as curing agents include, but are not limited to, maleic anhydride; methyltetrahydrophtalic anhydride; methyl-4-endomethylene tetrahydrophtalic anhydride; hexahydrophtalic anhydride; tetrahydrophtalic anhydride; dodecenyl succinic anhydride. An exemplary anhydride hardener is methyltetrahydrophtalic anhydride (MTHPA).

The stoichiometry of anhydride hardener may vary from a molar defect to a molar excess of the anhydride with respect to the sum of the epoxide groups present, i.e. calculated to the epoxide groups of the sum of the DGEBA and DGEBF present. An exemplary molar ratio of the anhydride groups ranges from 90% to 110%, such as, for example, 98% to 102%, calculated to the epoxide groups. When used to cure the mixture of DGEBA and DGEBF, the anhydride hardener, for example, the methyltetrahyrophtalic anhydride (MTHPA), can be present in an amount of from 40% to 120% by weight [also named as parts per hundred (phr)], calculated to the weight of the sum of DGEBA and DGEBF, such as 50% to 90% by weight, or about 70% by weight, for example, calculated to the weight of the sum of DGEBA and DGEBF.

An exemplary composition according to the present disclosure includes at least one plasticizer. The plasticizer may be a diol, including a diol which is solid at room-temperature. The plasticizer substantially functions as a flexibilizer. Examples of diols include aromatic diols such as bisphenol A, bisphenol F, aliphatic monomeric or polymeric diols such as polyethylene glycols (PEG) or polypropylene glycols (PPG), or neopentyl glycol. An exemplary embodiment provides that bisphenol A, bisphenol F and neopentyl glycol or a mixture of these compounds can be utilized as the diols. For example, neopentyl glycol and bisphenol A or a mixture of these compounds can be utilized. According to an exemplary embodiment, the plasticizer can be used in an amount of 5% to 50% by weight, calculated to the weight of the sum of DGEBA and DGEBF (e.g., 10% to 45% by weight), calculated to the weight of the sum of DGEBA and DGEBF. When both an aromatic and an aliphatic diol are used, their weight ratio may vary from 80:20 to 20:80, for example.

Many suitable catalysts may optionally be present in the composition for catalyzing the curing reaction of the epoxy resin with the hardener. The catalyst is, for example, a 1-substituted imidazole and/or N,N-dimethylbenzyl-amine.

Exemplary 1-substituted imidazole catalysts for the curing step are 1-alkyl imidazoles which may or may not be substituted also in the 2-position, such as 1-methyl imidazole or 1-isopropyl-2-methyl imidazole. Another exemplary catalyst is N,N-dimethylbenzylamine, and 1-methyl imidazole.

The optional catalyst can, for example, be used in amounts of less than 5% by weight, calculated to the total weight of DGEBA and DGEBF, such as within the range of 0.01% to 2.5% by weight, calculated to the total weight of DGEBA and DGEBF, e.g., within the range of 0.05% to 1% by weight, calculated to the total weight of DGEBA and DGEBF.

The dynamic complex viscosity value (η*) of the composition according to the present disclosure can be within the range of 0.1 to 20 Pa·s, such as 0.2 to 10 Pa·s, 0.5 to 2.0 Pa·s, and approximately 1.0 Pa·s, for example. The dynamic complex viscosity value (η*) given in Pa·s is measured at 75° C., 50% strain and 1 hz, according to the ISO standard 6721-10, second edition (dated 1999, part 10).

The cure time can be within the range of 4 hours to 10 hours, and within a temperature range of about 100° C. to 170° C. According to an exemplary embodiment, the temperate is approximately 130° C., for obtaining advantageous physical properties.

According to an exemplary embodiment of the present disclosure, the insulator system can include at least one filler material or a mixture of such filler materials. According to an exemplary embodiment, the fillers may be selected from the group consisting of natural purified sands; silicon oxides and silicon hydroxides; aluminum oxides and aluminum hydroxides; titanium oxides and titanium hydroxides; zinc oxides and hydroxides; silicates, such as sodium/-potassium silicates, silicon aluminosilicates; mineral carbonates, such as calcium-magnesium carbonate or calcium-silicon-magnesium carbonates; geo-polymers, such as trolites and/or zeolites based on aluminosilicates or other alkaline earth metals, glasses, mica, ceramic particles. According to an exemplary embodiment, silicon oxides, aluminum oxides, titanium oxides, silicates, including, for example, silicon oxides (SiO₂, Quarz), aluminum oxides and hydroxides, zinc oxide, sodium/potassium silicates and/or silicon aluminosilicates may be used as the filler. The filler may be surface treated, e.g. silanized, or untreated or be mixture thereof.

The mineral filler compound or the mixture of such compounds have a preferred average grain size (at least 50% of the grains) in the range of from about 1.0 μm to 2000 μm, such as in the range of 5 μm to 500 μm, or in the range of 5 μm to 100 μm, for example.

Filler loading in the composition can vary within a broad range, depending on the final application of the resin. Loading can be from about 50% to about 80% by weight, calculated to the total weight of the insulation composition, such as about 55% to about 75% by weight, or about 60% to about 70% by weight, for example, calculated to the total weight of the insulation composition.

The curable epoxy resin composition of the present disclosure may contain other additives, such as hydrophobic compounds, including, for example, a polysiloxane or a mixture of polysiloxanes; elastomers; pigments, dyes or stabilizers.

Suitable hydrophobic compound or a mixture of such compounds, especially for improving the self-healing properties of the electrical insulator may be selected from the group consisting of: flowable fluorinated or chlorinated hydrocarbons which contain —CH₂-units, —CHF-units, —CF₂-units, —CF₃-units, —CHCl-units, —C(Cl)₂-units, —C(Cl)₃-units, or mixtures thereof; or a cyclic, linear or branched flowable organopolysiloxane. The hydrophobic compound or the mixture of the compounds may be present in an encapsulated form.

The hydrophobic compound can, for example, have a viscosity in the range of 50 cSt to 10,000 cSt, such as in the range of 100 cSt to 10,000 cSt, and/or in the range of 500 cSt to 3000 cSt, measured in accordance with DIN 53 019 at 20° C.

Suitable polysiloxanes are known and may be linear, branched resp. cross-linked or cyclic. For example, the polysiloxanes can be composed of —[Si(R)(R)O]-groups, wherein R independently of each other is an unsubstituted or substituted, fluorinated, alkyl radical having from 1 to 4 carbon atoms, or phenyl, methyl, and wherein the substituent R may carry reactive groups, such as hydroxyl or epoxy groups. Non-cyclic siloxane compounds on average have about from 20 to 5000, 50-2000, —[Si(R)(R)O]-groups. Examples of cyclic siloxane compounds are those comprising 4-12, and 4-8, —[Si(R)(R)O]-units.

The hydrophobic compound can be added to the epoxide resin in an amount of from 0.1% to 10%, such as in an amount of 0.25% to 5% by weight, in an amount of from 0.25% to 3% by weight, for example, calculated to the weight of the sum of DGEBA and DGEBF.

Examplary elastomers are natural rubber, butyl rubber, polyisoprene, polybutadiene, polyisobutylene, ethylene-propylene copolymer, styrene-butadiene-styrene copolymer, styrene-isoprene-styrene copolymer and/or ethylene-propylene copolymer. These additives may be added provided viscosity values do not become too high. Pigments, dyes and stabilizers to optionally be added are known per se.

Exemplary processes for making the cured epoxy resin compositions of the present disclosure are the APG Process and the Vacuum Casting Process, for example. As mentioned above, such processes typically include a curing step in the mold for a time sufficient to shape the epoxy resin composition into its final infusible three dimensional structure, such as up to ten hours, for example, and a post-curing step of the demolded article at elevated temperature to develop the ultimate physical and mechanical properties of the cured epoxy resin composition. Such a post-curing step may take, depending on the shape and size of the article, up to thirty hours.

An exemplary process for making shaped articles using a composition according to the present disclosure can include the steps of:
(a) preheating a curable liquid epoxy resin composition comprising (i) at least one diglycidyl ether of bisphenol A (DGEBA) and at least one diglycidyl ether of bisphenol F (DGEBF) as epoxy resins, in which the weight ratio of DGEBA:DGEBF is within the range of about 15:85 to 45:55; (ii) an anhydride hardener; (iii) at least one plasticizer, such as a diol, including a diol which is solid at room temperature, for example; and (iv) optionally a catalyst, at least one filler material and/or further additives. The dynamic complex viscosity value (n*) of the composition is within the range of 0.1 to 20 Pa·s;
(b) transferring the composition into a pre-heated mold;
(c) curing the composition at an elevated temperature for a time sufficient to obtain a shaped article with an infusible cross-linked structure; and
(d) optionally post curing the obtained shaped article for about ten hours at a temperature of about 140° C.

Examples of compositions are as follows:

| Components: | Parts by weight: | % by weight: |
|---|---|---|
| DGEBA + DGEBF | 100 | 7.4-33.3 |
| Hardener | 40-120 | 2.9-40 |
| Catalyst | 0.01-5.0 | 0.04-1.7 |
| Plasticizer | 10-45 | 0.4-15 |
| Filler | 150-1080 | 50-80 |
| Optional additives | 0-20 | ad 100 |

Exemplary uses of the insulation systems produced according to the present disclosure can be dry-type transformers, particularly cast coils for dry type distribution transformers, including vacuum cast dry distribution trans-formers, within which the resin structure contains electrical conductors; high-voltage insulations for indoor use, such as breakers or switchgear applications; as long-rod, composite and cap-type insulators, and also for base insulators in the medium-voltage sector; in the production of insulators associated with outdoor power switches; measuring transducers, leadthroughs, and overvoltage protectors, in switchgear constructions, in power switches, and electrical machines, as coating materials for transistors and other semiconductor elements and/or to impregnate electrical components.

The present disclosure further encompasses electrical articles including an electrical insulation system according to any of the above-described exemplary embodiments of the present disclosure. The following examples are provided to illustrate exemplary implementations of the present disclosure. In the examples below, the disclosure is illustrated with reference to a Vacuum Casting Process, but they are not to be construed as to limiting the scope thereof in any manner.

### Examples 1 and Comparative Example

Glass Transition Temperature, Tg (° C.) was measured by the procedure according to ISO 11357-2.
Flexural properties were determined by the 3 points Bending Test to according ISO 178.

A curable epoxy resin composition according to the present disclosure (Example 1) and one comparison composition according to the prior art (Comparative Example according to EP 1 491 566) were prepared with a composition as set forth in Table 1 below. The components of the composition are expressed in parts by weight.

TABLE 1
(compositions)

| | Comparative | |
|---|---|---|
| Components | Example | Example 1 |
| DGEBA | 100 | 25 |
| DGEBF | — | 75 |
| MTHPA | 70 | 70 |
| NPG | 12 | 12 |
| Catalyst | 1.0 | 1.0 |
| Silica W12 | 320 | 320 |

DGEBA = diglycidylether of bisphenol A
DGEBF = diglycidylether of bisphenol F
MTHPA = methytetrahydrophtalic anhydride (hardener)
NPG = neopentylglycol (flexibilizer)
Catalyst = 1-methylimidazole
Silica W12, supplied by Quarzwerke Frechen

### Sample Preparation and Test Conditions

The silica filler was dried overnight at 160° C. and cooled down to 65° C. Each component (resin, hardener, flexibilizer) was preheated separately to 65° C. The mixing was carried out in small aluminum buckets with an overhead stirrer. Degassing was performed at 65° C. and 1 hPa before and after casting. Plates were vacuum cast (4 mm thickness) and subsequently cured for eight hours at 140° C. Test specimen were prepared according to the respective standards specifications. Results are listed in Table 2.

TABLE 2
(properties)

| | Comparative | |
|---|---|---|
| | Example | Example 1 |
| Thermal properties: Tg | 91° C. | 89° C. |
| Flexural properties: | | |
| Strength | 133.0 MPa | 143.5 MPa |
| Deformation at break | 1.48% | 1.65% |

With the composition of Example 1, which differs from the Comparative Example only with the replacement of DGEBA by a combination of DGEBA and DGEBF, flexural properties are surprisingly improved and the Tg is retained. Similar results are obtained without adding a 1-methylimidazole catalyst.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A curable epoxy resin composition, wherein said composition comprises:
(i) at least one diglycidyl ether of bisphenol A (DGEBA) and at least one diglycidyl ether of bisphenol F (DGEBF) as epoxy resins, wherein the weight ratio of DGEBA:DGEBF is within the range of about 15:85 to 45:55;
(ii) an anhydride hardener; and
(iii) at least one plasticizer;
wherein the dynamic complex viscosity value (q*) of said composition is within the range of 0.1 to 20 Pa·s, measured according to the ISO standard 6721-10.

2. The composition according to claim 1, wherein the weight ratio of DGEBA:DGEBF is within the range of 20:80 to 40:60.

3. The composition according to claim 1, wherein the anhydride hardener is selected from the group consisting of: maleic anhydride, methyltetrahydrophtalic anhydride, methyl-4-endomethylene tetrahydrophtalic anhydride, hexahydrophtalic anhydride, tetrahydrophtalic anhydride, and dodecenyl succinic anhydride.

4. The composition according to claim 1, wherein the plasticizer is selected from the group consisting of aromatic diols, aliphatic monomeric diols, aliphatic polymeric diols, and a mixture thereof.

5. The composition according to claim 4, wherein the plasticizer is present in an amount of from 5% to 50% by weight, calculated to the weight of the sum of the DGEBA and the DGEBF.

6. The composition according to claim 4, comprising an aromatic and an aliphatic diol having a weight ratio within the range of 80:20 to 20:80.

7. The composition according to claim 1, wherein the composition comprises a catalyst constituted by a 1-substituted imidazole and/or N,N-di-methylbenzylamine.

8. The composition according to claim 1, wherein the composition comprises a catalyst present in an amount of less than 5% by weight, calculated to the total weight of the DGEBA and DGEBF.

9. The composition according to claim 1, wherein the dynamic complex viscosity value (η*) of the composition is within the range of 0.2 to 10 Pa·s.

10. The composition according to claim 1, wherein the composition comprises at least one filler material constituting a mineral filler.

11. The composition according to claim 10, wherein a compound or mixture of the filler has an average grain size in the range of 1.0 μm to 2000 μm, and are present in an amount of 50% to 80% by weight, calculated to the total weight of the insulation composition.

12. The composition according to claim 1, wherein said composition comprises additives selected from the group consisting of hydrophobic compounds, elastomers, pigments, dyes and stabilizers.

13. The composition according to claim 1, wherein said composition is, in percentage by weight, comprised of 7.4 to 33.3% of the sum of the DGEBA+DGEBF, 2.9 to 40% of the anhydride hardener, 0.04 to 1.7% of a catalyst, 0.4 to 15% of the at least one plasticizer, and 50-80% of a filler.

14. A process for making a shaped article using a composition according to claim 1, comprising the steps of:
(a) preheating a curable liquid epoxy resin composition comprising (i) at least one diglycidyl ether of bisphenol A (DGEBA) and at least one diglycidyl ether of bisphenol F (DGEBF) as epoxy resins, (ii) an anhydride hardener; and (iii) at least one plasticizer, wherein the weight ratio of DGEBA:DGEBF is within the range of about 15:85 to 45:55, and the dynamic complex viscosity value (η*) of said composition is within the range of 0.1 to 20 Pa·s;
(b) transferring said composition into a pre-heated mold; and
(c) curing said composition at an elevated temperature for a time sufficient to obtain a shaped article with an infusible cross-linked structure.

15. An electrical article including an electrical insulation system constituted by said composition according to claim 1.

16. The composition according to claim 1, wherein the at least one plasticizer is a diol.

17. The composition according to claim 16, wherein the diol is solid at room temperature.

18. The composition according to claim 1, comprising:
a catalyst, at least one filler material and additives.

19. The composition according to claim 2, wherein the weight ratio of DGEBA DGEBF is within a range of 25:75 to 35:65.

20. The composition according to claim 1, wherein the anhydride hardener comprises methyltetrahydrophtalic anhydride (MTHPA).

21. The composition according to claim 4, wherein the plasticizer is selected from the group consisting of bisphenol A, bisphenol F, polyethylene glycols, polypropylene glycols, neopentyl glycol, and a mixture thereof.

22. The composition according to claim 4, wherein the plasticizer is selected from the group consisting of bisphenol A, bisphenol F, neopentyl glycol, and a mixture thereof.

23. The composition according to claim 5, wherein the plasticizer is present in an amount of from 10% to 45% by weight, calculated to the weight of the sum of the DGEBA and the DGEBF.

24. The composition according to claim 5, comprising an aromatic and an aliphatic diol having a weight ratio within the range of 80:20 to 20:80.

25. The composition according to claim 7, wherein the catalyst is a 1-alkyl imidazole which is substituted in the 2-position.

26. The composition according to claim 7, wherein the catalyst is 1-methyl imidazole or 1-isopropyl-2-methyl imidazole and/or 1-methyl imidazole.

27. The composition according to claim 7, wherein the catalyst is present in an amount of less than 5% by weight, calculated to the total weight of the DGEBA and DGEBF.

28. The composition according to claim 7, wherein the catalyst is present in an amount within the range of 0.01% to 2.5% by weight, calculated to the total weight of the DGEBA and DGEBF.

29. The composition according to claim 7, wherein the catalyst is present in an amount within the range of 0.05% to 1% by weight, calculated to the total weight of the DGEBA and DGEBF.

30. The composition according to claim 8, wherein the catalyst is present in an amount within the range of 0.01% to 2.5% by weight, calculated to the total weight of the DGEBA and DGEBF.

31. The composition according to claim 8, wherein the catalyst is present in an amount within the range of 0.05% to 1% by weight, calculated to the total weight of the DGEBA and DGEBF.

32. The composition according to claim 1, wherein the dynamic complex viscosity value (η*) of the composition is within the range of 0.5 to 2.0 Pa·s.

33. The composition according to claim 1, wherein the dynamic complex viscosity value (η*) of the composition is about 1.0 Pa·s.

34. The composition according to claim 10, wherein the filler is selected from the group consisting of silicon oxides, aluminum oxides, titanium oxides, silicates, zinc oxide, sodium/potassium silicates and silicon aluminosilicates.

35. The composition according to claim 34, wherein the silicates are selected from the group consisting of silicon oxides, aluminum oxides and hydroxides.

36. The composition according to claim 10, wherein the filler is surface treated.

37. The composition according to claim 10, wherein a compound or mixture of the filler has an average grain size in the range of from 5 μm to 500 μm, and are present in an amount of 55% to about 75% by weight, calculated to the total weight of the insulation composition.

38. The composition according to claim 10, wherein a compound or mixture of the filler has an average grain size in the 5 μm to 100 μm, and are present in an amount of about 60% to about 70% by weight, calculated to the total weight of the insulation composition.

39. The composition according to claim 12, wherein the hydrophobic compounds comprise a polysiloxane or a mixture of polysiloxanes.

40. The composition according to claim 11, wherein said composition is, in percentage by weight, comprised of 7.4 to 33.3% of the sum of the DGEBA+DGEBF, 2.9 to 40% of the anhydride hardener, 0.04 to 1.7% of a catalyst, 0.4 to 15% of the at least one plasticizer, and 50-80% of the filler.

41. The process according to claim 14, wherein the at least one plasticizer is a diol.

42. The process according to claim 41, wherein the diol is solid at room temperature.

43. The process according to claim 14, wherein composition includes a catalyst, at least one filler material, and additives.

44. The process according to claim 14, comprising post curing the obtained shaped article for approximately ten hours at a temperature of approximately 140° C.

45. The electrical article according to claim 15, comprising a dry-type trans-former including cast coils.

46. The electrical article according to claim 45, wherein the dry-type transformer is a vacuum cast dry distribution transformer having a resin structure that contains electrical conductors.

47. The electrical article according to claim 15, wherein the insulation system includes insulation selected from the group consisting of a high-voltage insulation for indoor use, composite and cap-type insulators, base insulators in a medium-voltage sector, insulators associated with outdoor power switches.

48. The electrical article according to claim 15, comprising a device selected from the group consisting of a measuring transducer, a leadthrough, and an overvoltage protector, a power switch, a coating material for a semiconductor element, and an element to impregnate electrical components.
